(19) United States
(12) Patent Application Publication
(10) Pub. No.: US 2005/0170128 A1
(43) Pub. Date: Aug. 4, 2005

(54) Bag-packed three-dimensional decorative sticker

(75) Inventor: Ming Te Lai, Yonghe City (CN)

Correspondence Address: TROXELL LAW OFFICE PLLC, 5205 LEESBURG PIKE, SUITE 1404, FALLS CHURCH, VA, 22041, US

(73) Assignee: Jean Card and Gift Co., Ltd.

(21) Appl. No.: 10/770,412

(22) Filed: Feb. 4, 2004

(51) Int. Cl. B32B 9/00

(52) U.S. Cl. 428/42.3

(57) ABSTRACT

A bag-packed three-dimensional (3D) decorative sticker set includes a packing bag defining a receiving space and adapted to hang on a display rack or rail, a substrate suitable for positioning in the packing bag and having a front allowing an adhesive-applied surface to repeatedly detachably attached thereto, and a plurality of individual 3D decorative stickers together creating a specific view and being preliminarily attached at an adhesive-applied backside to the front of the substrate for positioning in the packing bag along with the substrate.

The present invention relates to a bag-packed three-dimensional (3D) decorative sticker set, and more particularly to a set of correlated 3D decorative stickers received in the same one packing bag to create a stereo visual effect while being displayed. Any one of the 3D decorative stickers may be independently attached to any article or place at a consumer's full discretion.

### BACKGROUND OF THE INVENTION

A self-adhesive sticker developed at early stage mainly includes a simple flat design printed on a surface of the sticker. The above-structured conventional stickers may be attached to, for example, books, cards, present tags, walls, door leaves, etc., depending on the designs printed on the stickers, so as to create a decorative effect.

FIG. 1 shows the structure of conventional stickers. A substrate 10, usually made of a thin plastic sheet and having a predetermined size, is provided thereon with a plurality of individual flat designs 11. Each of the flat designs 11 is provided along an outer border with a cutting line 12, so that the flat design 11 may be easily separated from the substrate 10 at the cutting line 12 and attached at an adhesive-applied backside to a surface to be decorated.

Most of the conventional self-adhesive stickers show only flat carton figures or funny designs, and therefore provide relatively monotonous decorative effect. These flat stickers are usually stacked over one another in a store and therefore less attractive to general consumers.

U.S. Pat. No. 6,475,587B1 discloses a self-adhesive decorative device having a supporting release layer, a flexible backing layer, an adhesive layer applied to one side of the flexible backing layer and covered by the supporting release layer before being used, and a decorative layer provided on the surface of the flexible backing layer and printed with a decorator. The decorator includes two wings and is provided along a border thereof with a cutting line, which penetrates the decorative layer and the flexible backing layer but not the supporting release layer. A stripe of adhesive is provided in an area between the two wings of the decorator to adhere the decorative layer to the flexible backing layer, so that the two wings of the decorator are movable and may be folded along the stripe of adhesive.

When the supporting release layer is peeled to expose the adhesive layer, the decorative layer may be adhered to an article to be decorated. The two wings of the decorator may be folded along the stripe of adhesive to an upright position, so as to form a three-dimensional sticker. It is inconvenient for a consumer to first adhere the decorative layer to a desired article or surface and then fold the two wings. Moreover, the self-adhesive decorative device is close to a flat sticker before the two wings of the decorator are folded to the upright position. That is, the self-adhesive decorative device disclosed in U.S. Pat. No. 6,475,587B1 is actually a flat or two-dimensional product when it is displayed in a store for sale and is therefore less attractive to consumers.

### SUMMARY OF THE INVENTION

A primary object of the present invention is to provide a bag-packed 3D decorative sticker set that includes a plurality of individual 3D decorative stickers packed in the same one packing bag to together create a specific view and a stereo visual effect when being hung on a display rack or rail, so that consumers are attracted and stimulated to buy the stickers.

Another object of the present invention is to provide a bag-packed 3D decorative sticker set that includes a plurality of individual 3D decorative stickers packed in the same one packing bag to together create a specific view but may be independently attached to any article or any place at the consumer's full discretion as an intellectual game.

To achieve the above and other objects, the bag-packed 3D decorative sticker set according to the present invention mainly includes a packing bag defining a receiving space and adapted to hang on a display rack or rail, a substrate suitable for positioning in the packing bag and having a front allowing an adhesive-applied surface to repeatedly detachably attached thereto, and a plurality of individual 3D decorative stickers together creating a specific view and being preliminarily attached at an adhesive-applied backside to the front of the substrate for positioning in the packing bag along with the substrate.

In a preferred embodiment of the present invention, the substrate is a transparent thin sheet.

In an alternative embodiment of the present invention, the substrate has an opaque paper sheet laminated to a backside thereof for showing information about using the 3D decorative sticker set, and the opaque paper sheet has a size close to that of the substrate.

In an embodiment of the present invention, the set of 3D decorative stickers are formed through overlapping different constituent parts.

In an alternative embodiment of the present invention, the set of 3D decorative stickers are formed through curling a plurality of long paper or plastic strips having predetermined widths.

In an alternative embodiment of the present invention, the set of 3D decorative stickers are formed from a plurality of serially connected and/or stacked beads.

In a preferred embodiment of the present invention, the set of 3D decorative stickers together create a view of flowering plants.

In an alternative embodiment of the present invention, the set of 3D decorative stickers together create a view of woman's personal items.

In still an alternative embodiment of the present invention, the set of 3D decorative stickers together create a view of fairy tale.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows the structure of conventional stickers;

FIG. 2 is a perspective view of a bag-packed 3D decorative sticker set according to a first embodiment of the present invention;

FIG. 3 is an exploded perspective view of FIG. 2;

FIG. 4 is a sectioned side view of FIG. 2;

FIG. 5 is an enlarged perspective view of one of the 3D decorative stickers packed in a packing bag of FIG. 2;

FIG. 6 shows another example of 3D decorative sticker suitable for packing in a bag according to the present invention;

FIG. 7 shows a further example of 3D decorative sticker suitable for packing in a bag according to the present invention;

FIG. 8 shows a bag-packed 3D decorative sticker set according to a second embodiment of the present invention; and

FIG. 9 shows a bag-packed 3D decorative sticker set according to a third embodiment of the present invention.

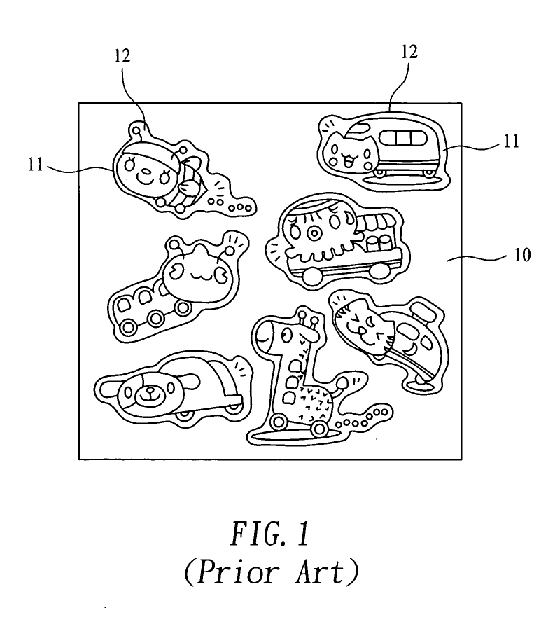

### DETAILED DESCRIPTION OF THE PREFERRED EMBODIMENTS

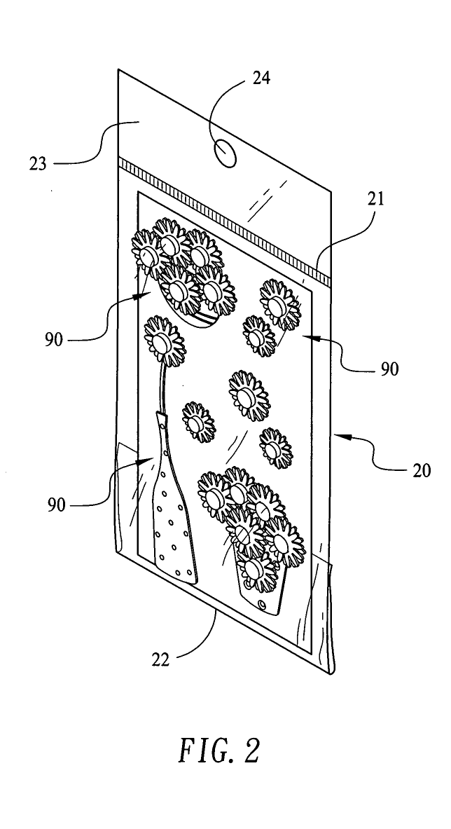

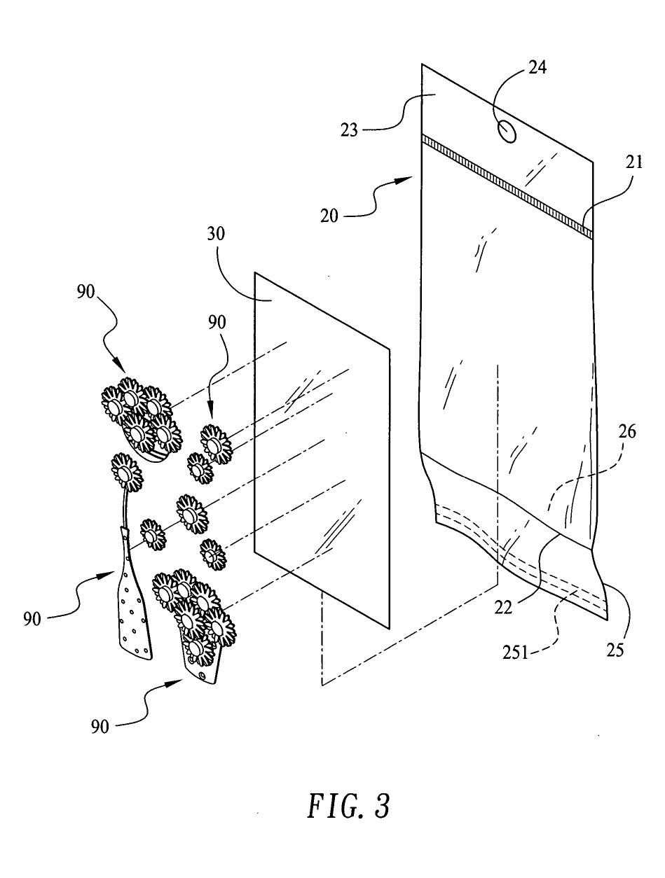

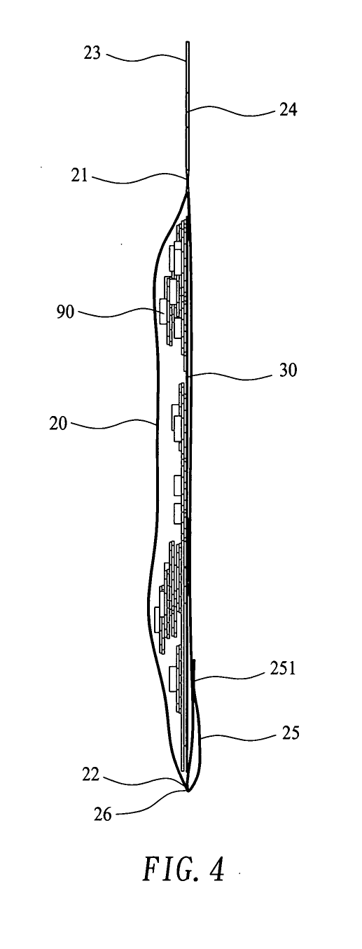

Please refer to FIGS. 2 to 4 that are assembled perspective, exploded perspective, and sectioned side views, respectively, of a bag-packed 3D decorative sticker set according to a first embodiment of the present invention. As shown, the present invention includes a packing bag 20 made of a transparent and thin plastic sheet to define a 3D receiving space for holding one or more 3D decorative stickers therein and adapted to hang on a display rack or rail for sale. In the illustrated first embodiment, the packing bag 20 includes a sealed upper edge 21 and an open lower edge 22, a top piece 23 located above the sealed upper edge 21 and provided with a hanging hole 24, and a flap 25 downward extended from the open lower edge 22. The flap 25 is provided along an inner end with a long strips of adhesive 251, which allows the flap 25 to fold upward and close an opening 26 defined by the open lower edge 22, or turn downward to expose the opening 26 forgetting or putting 3D decorative stickers 90 from or into the packing bag 20.

A substrate 30 having a predetermined size may be pre-positioned in the receiving space of the packing bag 20. The substrate 30 is preferably made of a transparent and thin plastic sheet, so that different 3D decorative stickers 90 may be preliminarily connected at an adhesive-applied backside to a front of the substrate 30 in a repeatedly removable and attachable manner. It is preferable the substrate 30 made of a transparent thin plastic sheet has sufficient stiffness for it to stand upright when it is vertically positioned in the packing bag 20 hung on the display rack or rail.

A sheet of opaque paper (not shown) having a size close to that of the substrate 30 may be laminated to a backside of the substrate 30. Information such as use instructions, articles or positions suitable for using the 3D decorative stickers, descriptions of functions obtainable from the 3D decorative stickers, etc. may be printed on the opaque paper before the latter is laminated to the transparent substrate 30.

One or more 3D decorative stickers 90 may be attached to the front of the substrate 30 to together create a special stereo visual effect when the packing bag 20 is hung on the display rack or rail. Since the decorative stickers 90 are directly provided at respective backside with bonding agent, either a double-side adhesive tape or a layer of adhesive, in the manufacturing process, they could be preliminarily fixed to the front of the substrate 30.

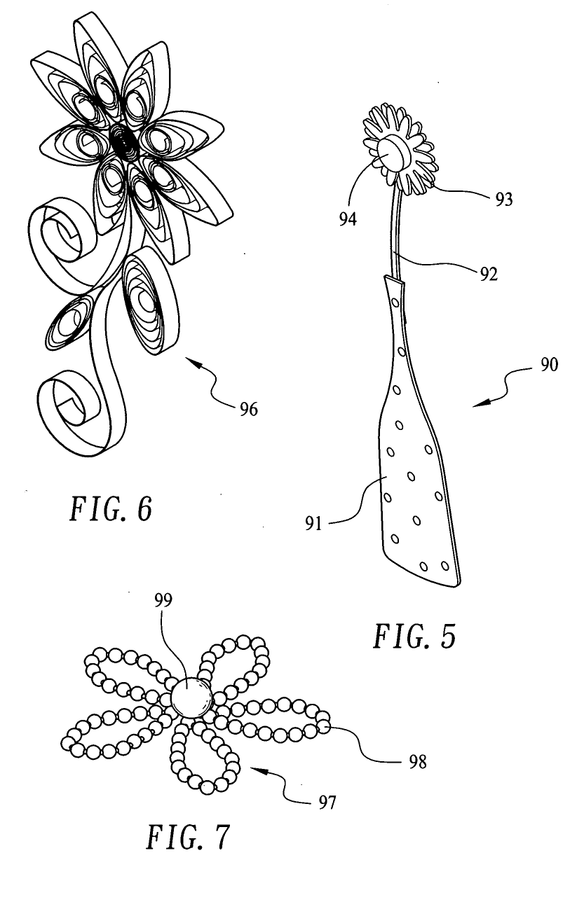

The 3D decorative stickers 90 may be differently formed. For example, in the illustrated first embodiment, one of the 3D decorative stickers 90 packed in the packing bag 20 is a vase 91 holding a flower 93, as shown in FIG. 5. A stem 92 of the flower 93 has upper and lower ends overlapping backsides of the flower 93 and the vase 91, respectively. And, a stamen 94 is stacked on a front center of the flower 93. In this structuring manner, the whole decorative sticker presents three-dimensional flowering plant and vase to create more fun than general printed designs.

FIG. 6 shows another type of 3D decorative sticker 96 that is a flower with stem and leaves and is formed by curling paper or plastic strips of a predetermined width.

FIG. 7 shows a further type of 3D decorative sticker 97, which is a pattern formed from a plurality of serially connected beads 98, and has a larger bead 99 superposed on a center of the pattern to create a stereo visual effect.

In the above-described embodiment, a plurality of individual 3D decorative stickers 90 for showing a specific view are preliminarily adhered to the front of the substrate 30, and then positioned in the packing bag 20 along with the substrate 30 for hanging on the display rack or rail for sale.

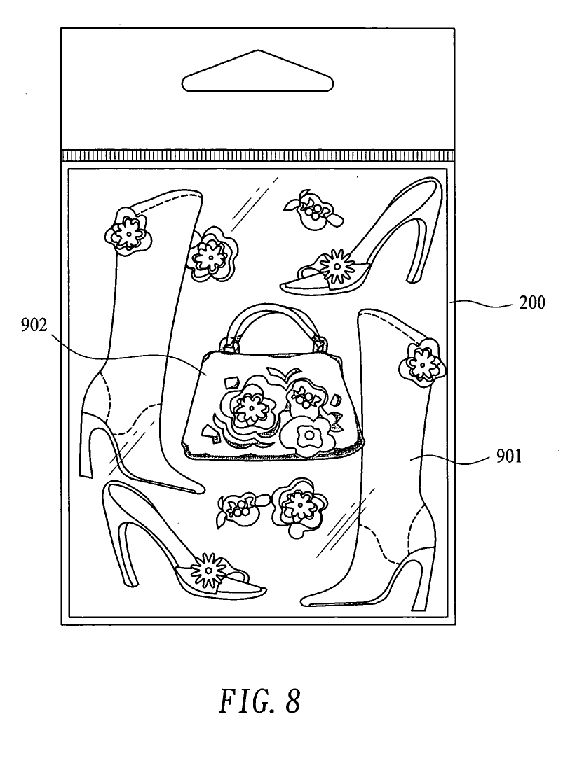

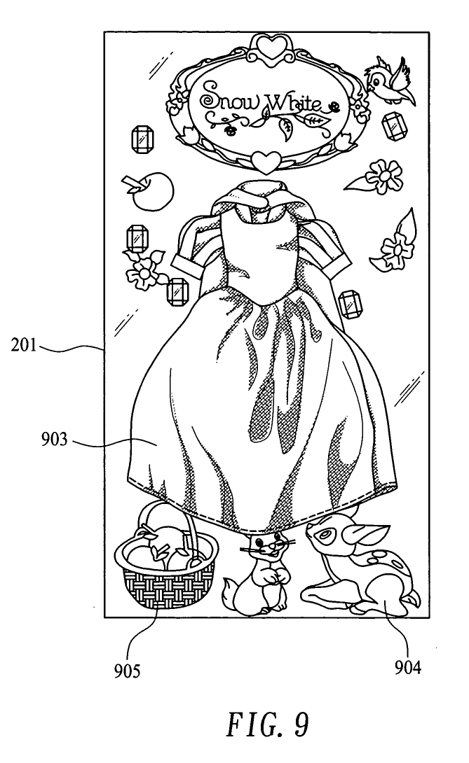

For the purpose of the first embodiment shown in FIGS. 2 to 5, the individual 3D decorative stickers 90 positioned in the same one packing bag 20 to show a specific view include different 3D flowers, a 3D vase, and a 3D flowerpot. FIG. 8 shows another embodiment of the present invention, in which a variety of woman's personal items, including high-heeled top boots 901, handbag 902, etc., packed in a packing bag 200. FIG. 9 shows a further embodiment of the present invention, in which 3D decorative stickers showing doll costume 903, cute animals 904, and basket 905 normally presented in fairy tales are packed in a packing bag 201.

When a plurality of individual 3D decorative stickers together creating a specific view are positioned in the same one packing bag for hanging on a display rack or rail in a store, a special stereo vision would be advantageously created to attract more consumers. Meanwhile, a user may unpack the packing bag to use the individual 3D decorative stickers at full discretion. For example, the user may adhere the individual 3D decorative sticker to a present, a card, or a book cover, or combine them in any desired manner as an intellectual game.

The present invention has been described with some preferred embodiments thereof and it is understood that many changes and modifications in the described embodiments can be carried out without departing from the scope and the spirit of the invention that is intended to be limited only by the appended claims.

1. A bag-packed three-dimensional (3D) decorative sticker set, comprising:
a packing bag defining a receiving space and adapted to hang on a display rack or rail, said packing bag including a sealed upper edge and an open lower edge, and an adhesive-applied flap downward extended from said open lower edge; said flap being normally folded upward to close an opening at said open lower edge and adapted to turn downward again to expose said opening;
a substrate having a size suitable for positioning in said packing bag, and a front allowing an adhesive-applied surface to repeatedly detachably attached thereto; and
a set of individual 3D decorative stickers together creating a specific view, said 3D decorative stickers being preliminarily detachably adhered at an adhesive-applied backside to the front of said substrate, so as to be positioned into or removed from said packing bag along with said substrate.

2. The bag-packed 3D decorative sticker set as claimed in claim 1, wherein said substrate comprises an opaque thin sheet.

3. The bag-packed 3D decorative sticker set as claimed in claim 1, wherein said substrate comprises a transparent thin sheet.

4. The bag-packed 3D decorative sticker set as claimed in claim 1, wherein said substrate has an opaque paper sheet laminated to a backside thereof for showing information about using said 3D decorative sticker set, and said opaque paper sheet having a size close to that of said substrate.

5. The bag-packed 3D decorative sticker set as claimed in claim 1, wherein said set of 3D decorative stickers are formed by overlapping different constituent parts.

6. The bag-packed 3D decorative sticker set as claimed in claim 1, wherein said set of 3D decorative stickers are formed by curling a plurality of long paper or plastic strips having predetermined widths.

7. The bag-packed 3D decorative sticker set as claimed in claim 1, wherein said set of 3D decorative stickers are formed from a plurality of serially connected and/or stacked beads.

8. The bag-packed 3D decorative sticker set as claimed in claim 1, wherein said specific view created by said set of 3D decorative stickers includes flowering plants.

9. The bag-packed 3D decorative sticker set as claimed in claim 1, wherein said specific view created by said set of 3D decorative stickers includes woman's personal items.

10. The bag-packed 3D decorative sticker set as claimed in claim 1, wherein said specific view created by said set of 3D decorative stickers includes things related to fairy tales.

11. The bag-packed 3D decorative sticker set as claimed in claim 10, wherein said things related to fairy tales include doll costumes, cute animals, etc.

12. A bag-packed three-dimensional decorative sticker set, comprising:
a packing bag defining a receiving space and adapted to hang on a display rack or rail, said packing bag including a sealed upper edge and an open lower edge, and an adhesive-applied flap downward extended from said open lower edge; said flap being normally folded upward to close an opening at said open lower edge and adapted to turn downward again to expose said opening;
a substrate having a size suitable for positioning in said packing bag, and a front allowing an adhesive-applied surface to repeatedly detachably attached thereto; and
a set of individual 3D decorative stickers showing costumes and animals to create a specific fairy-tale view, said set of individual 3D decorative stickers being applied at a backside with adhesive adapted to preliminarily adhere to the front of said substrate, so as to be positioned into said packing bag along with said substrate.

13. The bag-packed 3D decorative sticker set as claimed in claim 12, wherein said substrate comprises an opaque thin sheet.

14. The bag-packed 3D decorative sticker set as claimed in claim 12, wherein said substrate has an opaque paper sheet laminated to a backside thereof for showing information about using said 3D decorative sticker set, and said opaque paper sheet having a size close to that of said substrate.

15. The bag-packed 3D decorative sticker set as claimed in claim 12, wherein said set of 3D decorative stickers are formed by overlapping different constituent parts.

16. The bag-packed 3D decorative sticker set as claimed in claim 12, wherein said set of 3D decorative stickers are formed by curling a plurality of long paper or plastic strips having predetermined widths.

17. The bag-packed 3D decorative sticker set as claimed in claim 12, wherein said set of 3D decorative stickers are formed from a plurality of serially connected and/or stacked beads.
